(19) United States
(12) Patent Application Publication
(10) Pub. No.: US 2009/0284890 A1
(43) Pub. Date: Nov. 19, 2009

(54) Mechanism and Method for Permanent Magnet Degaussing

(76) Inventor: LeRoy D. THIEL, Lincoln, NE (US)

Correspondence Address: FITCH EVEN TABIN & FLANNERY, 120 SOUTH LASALLE STREET, SUITE 1600, CHICAGO, IL, 60603-3406, US

(21) Appl. No.: 12/121,935

(22) Filed: May 16, 2008

(51) Int. Cl. H01F 13/00; H01H 47/00

(52) U.S. Cl. 361/149

(57) ABSTRACT

A system for degaussing magnetic media includes a media transport carousel mounted to move in a first direction into the system and through a magnetic field generator and to move in a second direction through the magnetic field generator and out of the system. An automatically reversible transmission transmits via a plurality of gears rotational force from an input shaft in a first rotational direction to drive the drive element and the media transport carousel in a first direction. The automatically reversible transmission is configured to transmit via a second plurality of gears the rotational force from the input shaft in the first direction to drive the drive element to move the media transport carousel in a second direction opposite of the first direction. A media rotation assembly automatically rotates the media transport carousel after it passes a distance through the magnetic field generator.

### TECHNICAL FIELD

This invention relates generally to magnetic field degaussers and more particularly to mechanisms for transporting a magnetic storage medium through a magnetic field.

### BACKGROUND

The art of bulk degaussing has been in use for many years. It is well understood that the exposure of magnetic storage media to magnetic fields that are orientated approximately 90 degrees apart is an effective means for achieving quality erasure for tape formats. There are many different media formats and information erasing standards that instruct how different formats need to be erased for the purpose of media disposal. When media is degaussed during a security emergency, speed of the erasing process and operator friendly operation of the equipment are of increased importance.

Bulk erasing systems can be found in many different styles including handheld, tabletop, drawer style, cavity degaussing, and conveyor type. Degaussing systems like handheld, tabletop, and most conveyor style equipment require the human operator to manually rotate and even flip the media between subsequent passes through the magnetic degaussing field for proper erasure. During security emergencies, however, these types of devices are not reliable because they rely on the skill and diligence of the human operator. Other styles of conveyor based degaussing equipment have been developed that use two or more magnet arrays for generating magnetic fields at 90 degrees with respect to each other. This type of equipment generally operates quickly and requires less operator skill; however, this style of equipment tends to be very large in size and can weigh more than 453 kilograms (1000 pounds). When permanent magnet material is used in two or more magnetic field generators for a single piece of equipment, the cost to produce such a device is generally high as well.

With the development of modern computer hard drives and stronger magnetic field generators, conveyor based degaussing systems are being constructed with heavy, cleated belts and large motors to move the hard drives through the magnetic fields. The larger motor required on these types of machines requires a higher electrical input voltage. Similarly, cavity degaussing devices, devices where a magnetic storage medium is placed in a cavity where magnetic fields are applied to erase the medium before the medium is removed from the cavity, generally employ high power electromagnets which can permit electronic manipulation of the strength and orientation of the magnetic field. This type of degaussing system generally requires a reliable industrial power source for continued operation and requires up to one minute for a complete degaussing process. These types of equipment, however, are not suited for use in an area with no electrical power or limited power.

Newer styles of computer hard drives that spin at 15,000 RPM or higher generally contain large pieces of ferrous materials and have covers fabricated from thick ferrous material. It is well known that the introduction of such a hard drive to a very strong magnetic field requires a large amount of force to extract it out of the degaussing volume. Drawer style degaussing systems employ a drawer to move the magnetic storage media through the degaussing field. When hard drives that contain large amounts of ferrous material are erased in this style of degaussing equipment, the operator is required to apply large amounts of force against the drawer to move the storage media through the magnetic field because of magnetic forces between the magnetic field and the drive and friction forces. The amount of force that is needed to be applied against the drawer can be equal to about ½ of the machine weight such that the machine may slide off of the table or other surface supporting the machine when the user pushes or pulls the media through the machine.

The machine can be secured to the supporting surface, but other operating problems may occur when the operator applies an adequate force to move the magnetic storage medium out of the magnetic field. As the media reaches the edge of the magnetic field volume, the magnetic attracting force quickly drops off and the operator can not respond quickly enough to gain control of the drawer motion. When this happens, the drawer may violently collide with other components inside the machine resulting in a damaged or broken mechanism. Drawer style degaussing systems have fast erasing times but require an operator with strong arms and who is well practiced at using the equipment. There is a need for an improved bulk degaussing system that is of a reduced size and cost, that reduces or eliminates the need for electrical power, that exposes magnetic storage media to strong magnetic fields having varying orientation, that reduces the amount of operator skill required, and that reduces the amount of force required by the operator to operate the machine in achieving quality erasure.

### BRIEF DESCRIPTION OF THE DRAWINGS

The above needs are at least partially met through provision of the improved mechanism and method for permanent magnet degaussing described in the following detailed description, particularly when studied in conjunction with the drawings, wherein:

FIG. 1 is a perspective view of an example degaussing system as configured in accordance with various embodiments of the invention;

FIG. 2 is a side view of the degaussing system of FIG. 1;

FIG. 3 is a perspective view of the example transmission of the degaussing system of FIG. 1;

FIG. 4 is a partial top view of the transmission of FIG. 3;

FIG. 5 is a side view of a clutch collar and bevel gear of FIG. 4;

FIG. 6 is a top view of the transmission of FIG. 5;

FIG. 7 is a bottom perspective view of the example media transport carousel of the degaussing system of FIG. 1;

FIG. 8 is a partial perspective view of the bottom of the turn table release assembly of the degaussing system of FIG. 1;

FIG. 9 is a partial top view of portions of the degaussing system of FIG. 1 used to unlock and rotate the turn table;

FIG. 10 is a partial top view of portions of the degaussing system of FIG. 1 used to unlock and rotate the turn table.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE PREFERRED EMBODIMENT

Generally speaking, pursuant to these various embodiments, a system for degaussing magnetic media includes a media transport carousel mounted within the system to move in a first direction into the system and through a magnetic field generator and to move in a second direction through the magnetic field generator and out of the system. A flexible drive member is in driving communication with the magnetic media carousel and a drive element to drive the magnetic media carousel. The system also includes an automatically reversible transmission in communication with an input shaft to transmit via a plurality of gears rotational force from the input shaft in a first rotational direction to drive the drive element so that the drive element moves the media transport carousel in a first direction. The automatically reversible transmission is configured to transmit via a second plurality of gears the rotational force from the input shaft in the first direction to drive the drive element to move the media transport carousel in a second direction opposite of the first direction. The system also includes a media rotation assembly selectively engaging the media transport carousel to automatically rotate the media transport carousel after the media transport carousel passes a distance through the magnetic field generator in the first direction.

So configured, the system moves a magnetic storage medium through a magnetic field, automatically rotates the medium, and returns the medium through the magnetic field for a user without forcing the user to stop rotating the input shaft, reversing rotation of the input shaft, or manually rotating the magnetic medium in between passes through the magnetic field. By eliminating these user steps, the opportunity for failure to erase the storage medium through user error is reduced. Also, by allowing the force driving the system to be input via a rotatable handle, problems regarding violent collisions within the system or tipping or moving the system while forcing the medium through strong magnetic fields are reduced. Moreover, the system may be implemented through manual rotation of the input shaft allowing reliable operation in situations without electrical power. These and other benefits may become clearer upon making a thorough review and study of the following detailed description of an illustrative system that is compatible with many of these teachings.

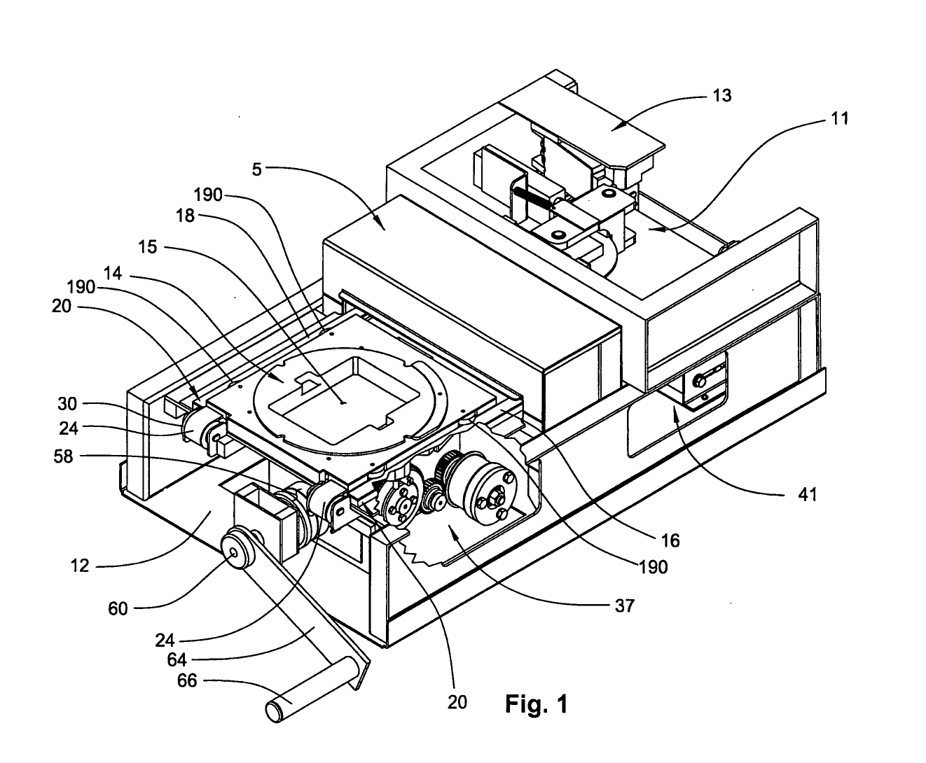

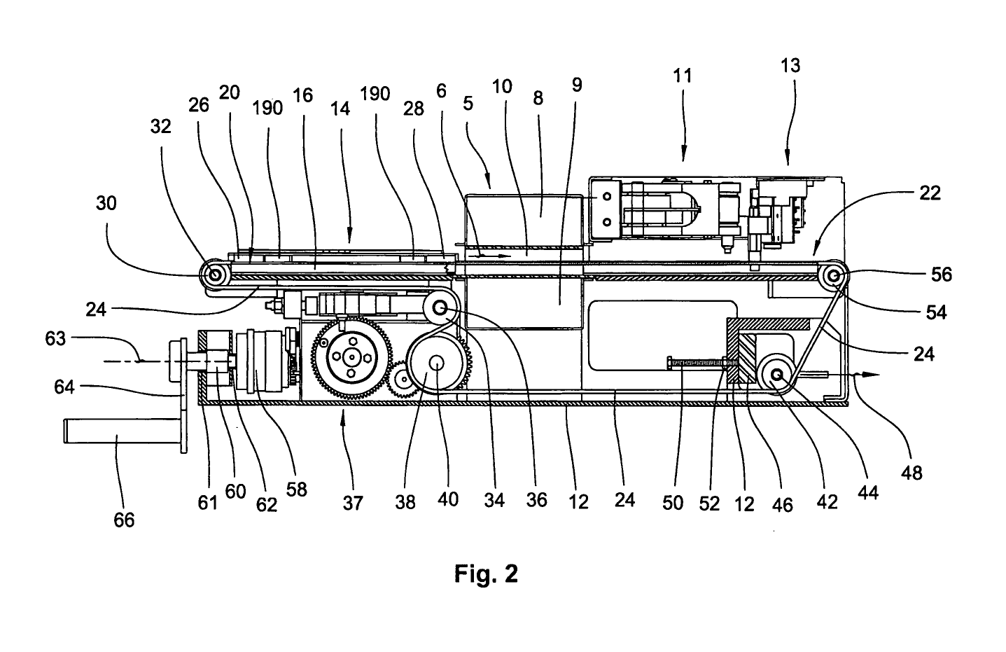

Referring to FIGS. 1 and 2, an example apparatus for degaussing magnetic storage media includes a magnetic field generator 5, a media transport carousel 14, a turn table release assembly 13, a transmission 37, and a media rotation assembly 11. The magnetic field generator 5 can come in many different forms. Electromagnets and permanent magnets are the most commonly used forms of magnetic field generation and could be used as the magnetic field generator 5. The illustrated example makes use of a permanent magnet structure comprised of a magnet portion 8 and a magnet portion 9. The two magnetic assemblages 8 and 9 are disposed on opposite sides of the magnetic media conveyance path 6 thereby defining a gap 10 that comprises one portion of the magnetic field volume. The depth of the illustrated magnetic field volume is greater than the length of the longest side of the magnetic storage medium that is desired to be degaussed in the mechanism. The magnetic field generator 5 is firmly attached to the frame 12 of the apparatus, which provides a common point of attachment for other items in this example. Further details regarding example magnetic field generators can be found in U.S. patent application Ser. No. 10/897,882, titled “Permanent Magnet Bulk Degausser,” and 11/457,687, titled “Method And Reciprocating Apparatus For Permanent Magnet Erasure Of Magnetic Storage Media,” which are incorporated by reference in their entirety herein.

The media transport carousel 14 is mounted within the system to move in a first direction into the system and through the magnetic field generator 5 and to move in a second direction through the magnetic field generator 5 and out of the system. The media transport carousel 14 includes, in part, the media cavity 15, a media turntable, a turntable lock, and other supporting rollers. The transport carousel 14 is supported on each side and constrained to linear motion by transport rails 16 and 18. Transport rails 16 and 18 run parallel to the media conveyance path 6 and bisect the magnetic field gap 10. These rails are comprised of one rail end 20 that lies toward the area where media is loaded and unloaded from the media cavity 15 and a second rail end 22 that is opposite that of rail end 20. Media cavity 15 is of an appropriate size for the storage medium to be degaussed, can be replaced to suit various storage media, and is located on the media transport carousel 14. During normal operation of the machine, the magnetic storage medium is placed within the media cavity 15 by the operator prior to degaussing. The operator will then apply power to move the media transport carousel 14 from a position near rail end 20 to a position near rail end 22 and then return to the starting position near rail end 20.

A flexible drive member is in driving communication with the magnetic media carousel 14 and a drive element to move the magnetic media along the media conveyance path 6. A flexible drive member can be found in many different forms such as chains, V belts, cable or others. The incorporation of more than one flexible drive member may be desired under some conditions. For example, when the magnetic field generator 5 produces a very high flux density in the magnetic field volume and the magnetic storage media contains large amount of ferrous material, multiple drive members may help in pulling media through the high interacting forces of the system. In the example of FIG. 1, two synchronous belts 24 act as the flexible drive members to move media transport carousel 14 through the effective magnetic erasing volume. One portion of belt 24 is attached to each outside region of media transport carousel 14. The synchronous belt can include a toothed belt containing a trapezoidal, HTD®, curvilinear, or some other profile. Belt 24 has one belt end 26 attached to the media transport carousel 14 in the direction of rail end 20 and a second belt end 28 attached to media transport carousel 14 opposite that of belt end 26.

FIG. 2 illustrates a partial section view of the mechanism showing a configuration of belt 24. Though only one belt is shown and described, the configuration of the two belts of this example are in all aspects identical. Belt 24 traverses a path that starts at belt end 26 and next engages sprocket 30 which has a toothed profile to match belt 24 and is allowed to freely rotate about sprocket shaft 32 that is firmly joined to frame 12. Belt idler 34 next receives belt 24. Belt idler 34 is supported by and freely rotates about idler shaft 36 being affixed to frame 12. Belt 24 next approaches and engages with the drive element of this example, drive sprocket 38, which has a matching toothed profile. Drive sprocket 38 is driven by drive shaft 40 in a manner that will be described herein. The rotational direction of drive sprocket 38 ultimately determines the direction of motion for media transport carousel 14. As viewed in FIG. 2, a clockwise rotation of drive sprocket 38 will produce a linear motion of media transport carousel 14 in a first direction to the right and conversely a counterclockwise rotation will move media transport carousel 14 in a second direction to the left. Drive sprocket 38 and drive shaft 40 are members of the transmission 37 that is described in detail later.

Belt 24 next comes into contact with belt tensioning assembly 41 that contains tensioning sprocket 42. The belt tensioning assembly 41 is comprised in part by a toothed sprocket, an adjustable housing member 46 and an adjustment screw 50. Shaft 44 is firmly affixed to adjustable housing 46 and allows tensioning sprocket 42 containing a synchronous tooth profile to freely rotate about the axial center. Adjustable housing 46 is aligned in a slot in frame 12 and allowed to move in the direction of arrow 48 when screw 50 is tightened. After the proper tension is produced within the belt 24 as is within the skill of one in the art, lock nut 52 is tightened. Belt 24 then exits adjustment sprocket 42 and engages sprocket 54 which has a toothed profile to match belt 24 and is allowed to freely rotate about sprocket shaft 56 that is firmly joined to frame 12. Belt 24 then concludes the belt path with a connection of belt end 28 to media transport carousel 14.

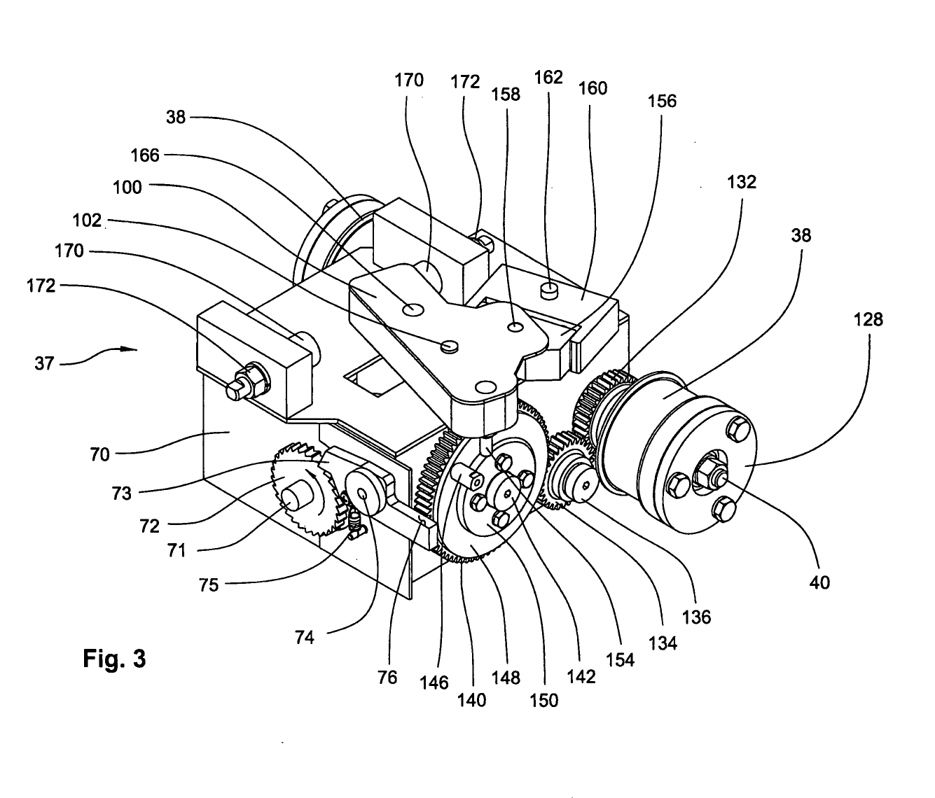

An automatically reversible transmission 37 is in communication with an input shaft 71 (see FIG. 3) to transmit via a plurality of gears a rotational force from the input shaft 71 in a first rotational direction to drive the drive element in a first drive element rotation direction, which in turn moves the media transport carousel 14 in the first direction into the system. The automatically reversible transmission 37 is also configured to transmit via a second plurality of gears the rotational force from the input shaft 71 in the first direction to drive the drive element in a second drive element rotation direction to move the media transport carousel 14 in the second direction through the magnetic field generator 5 and out of the system. A media rotation assembly selectively engages the media transport carousel 14 to automatically rotate the media transport carousel 14 after the carousel 14 passes a distance through the magnetic field generator 5 in the first direction.

Transmission 37 receives input power from clutch 58 which is rigidly affixed to the transmission input shaft 71 and also the handle shaft 60. Clutches are available in many different configurations and styles like friction pad type, ball detent type, over running, and many more. The characteristics of a single clutch unit can be altered to a given application through different engagement or disengagement styles or by combining two or more configurations. Clutch 58 in communication with input shaft 71 limits input torque applied to the input shaft 71 from an operator. The illustrated example uses a ball detent random reset slip clutch that is adjusted to a 300 inch-pound (33.9 newton meter) disengagement value to protect belt 24 and other components from damage due to a vast difference in input conditions from human operators, although other clutches may be used for this purpose. Handle shaft 60 is supported by bearings 61 and 62 that are both affixed to frame 12, and constrained to rotational motion about the axial centerline 63. Handle extension 64 is rigidly attached to handle shaft 60 and to handle 66. An external force that is applied to handle 66 imparts a rotational moment on handle shaft 60. The use of a handle as described allows for human powered, manual operation of the machine in the event that an external power source like electricity is interrupted or not available. Handle 66 and handle extension 64 could be replaced with some other means to cause rotational motion of handle shaft 60 such as, for example, an electric motor, internal combustion engine, or hydraulic/pneumatic device, among others.

With reference to FIGS. 3-6, transmission 37 provides rotational input and a way to sequence and time the reversal of motion for the media transport carousel 14 such that rotation in a single direction is transferred into reciprocating linear motion. Clutch 58 is firmly affixed to input shaft 71 and receives up to the maximum permissible torque that has been predetermined and preset. A rotation limiting device engages at least a portion of the system to substantially limit rotation of the input shaft 71 to rotation in one direction, which reduces the chance of not completing a full erasing cycle. In this example, ratchet 72 is rigidly attached to input shaft 71 and interacts with pawl 73 to permit only counterclockwise rotation of input shaft 71. This unidirectional input to shaft 71 simplifies the operator interaction in determining the correct time to reverse motion of media transport carousel 14 for proper machine operation. Pawl 73 freely rotates about pawl shaft 74 and is biased toward ratchet 72 by an external force that is generated in spring 75 being attached at one end to ratchet 73 and the other end to the transmission housing 70. If reversal of the rotation of input shaft 71 is desired, an external force applied at location 76 on pawl 73 will cause a rotation of this member about pawl shaft 74 and move it out of contact with ratchet 72.

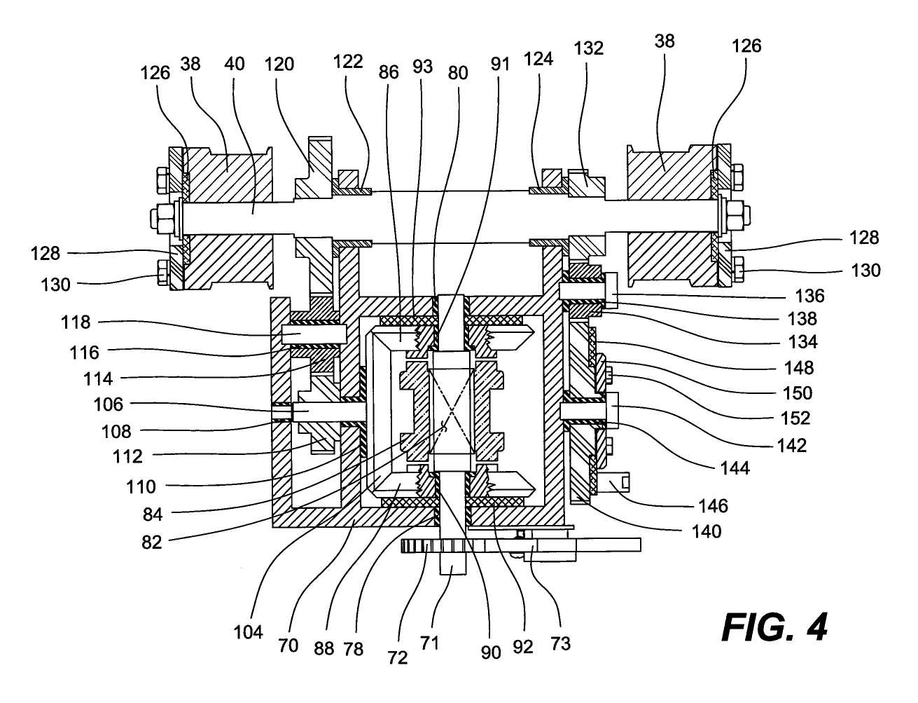

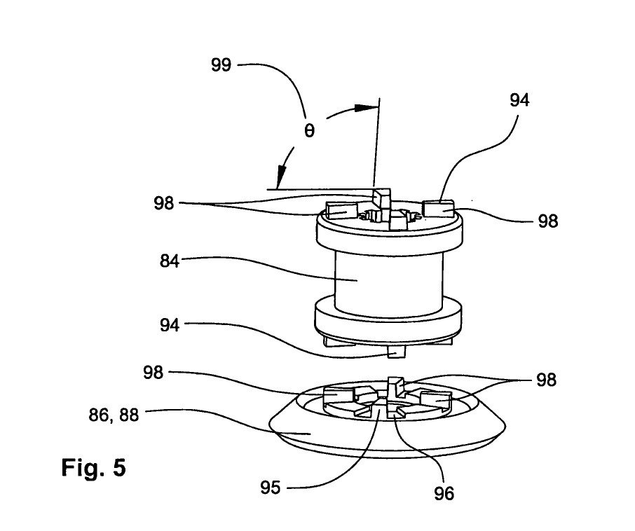

With reference to FIGS. 4 and 5, input shaft 71 is supported in transmission housing 70 by bearings 78 and 80 and constrained to rotational motion. Input shaft 71 drives clutch collar 84. Clutch collar 84 contains a splined portion that mates with a like splined portion on input shaft 71. The splined portion 82 allows clutch collar 84 to slide in an axial direction along input shaft 71 and rotate in unison with it.

Clutch collar 84 selectively engages one of a first gear 86 in driving communication with the drive element, in this case drive sprocket 38, and a second gear 88 in driving communication with the drive element. When clutch collar 84 engages and drives the first gear 86, the drive element is driven in a first drive element rotation direction, and when clutch collar 84 engages and drives the second gear 88, the drive element is driven in a second drive element rotation direction. So configured, when clutch collar 84 engages and drives the first gear 86, the magnetic media carousel 14 is driven in the first direction, and when clutch collar 84 engages and drives the second gear 88, the magnetic media carousel 14 is driven in the second direction. When the drive element is driven in the first direction, the magnetic media carousel 14 is driven into and through the magnetic field generator 5 before being rotated. When the drive element is driven in the second direction, the magnetic media carousel 14 is driven through the magnetic field generator 5 again and out of the system after being rotated. Reverse arm 100 controls or is in communication with clutch collar 84 to automatically bias clutch collar 84 to engage the second gear 88 after the drive element rotates a rotational distance in the first drive element rotation direction, corresponding to driving the media transport carousel 14 a distance through the magnetic field generator 5 in the first direction.

In the example of FIGS. 4, 5, and 6, depending on the position of reverse arm 100, clutch collar 84 will slide along input shaft 71 until it comes into contact with bevel gear 86 or bevel gear 88. Bevel gears 86 and 88 are permitted to freely rotate about input shaft 71 through bearings 90 and 91 and supported from axial forces by thrust bearings 92 and 93. Clutch collar 84 and bevel gears 86 and 88 contain finger like projections that interact with each other to transmit the rotational energy along the drive train path. Referring to FIG. 5, four wedge shaped collar fingers 94 are machined into the ends of clutch collar 84. The number of collar fingers 94 can be increased or decreased to optimize the transmission for a specific operating condition. For example, if it is desired to increase the torque carrying capacity and decrease the angular velocity of clutch collar 84, then one would increase the number of clutch fingers 94. Wedge shaped gear fingers 95 are machined into the face of bevel gears 86 and 88 with the same quantity and spacing as clutch fingers 94 on clutch collar 84. When clutch collar 84 is in full contact engagement with either bevel gear 86 or 88, clutch finger 94 rests in gear pocket 96, which is of a like profile. The torque that clutch collar 84 possesses is transmitted to clutch fingers 94, which in turn exert a force on gear fingers 95 to rotate bevel gear 86 or 88. The construction and geometry of the mechanism allows clutch collar 84 to only be in contact with either bevel gear 86 or bevel gear 88 at any given time.

When the clutch collar 84 is delivering a large amount of torque, the mating face forces between clutch finger 94 and gear finger 95 will also be very high. These high contact forces will require a large amount of axial force be applied to clutch collar 84 to begin its motion of disengaging from one gear and reengaging with the other gear. Clutch finger 94 and gear finger 95 each contain the mating contact surface side 98. When the plane that side 98 lays in is parallel to the direction of sliding motion, the sliding friction force between the mating surfaces is the greatest. To reduce the sliding friction force, the plane of side 98 is oriented to some angle 99 that is greater than 90 degrees. In the example of FIG. 5, side 98 contains an angle 99 that is 93 degrees. As angle 99 becomes larger, the torque transmitting capacity of clutch collar 84 will be reduced due to the sliding wedge action between clutch finger 94 and gear finger 95.

As illustrated in FIGS. 3 and 4, reverse arm 100 is rotated in a clockwise direction about arm pivot 102, which will push clutch collar 84 into engagement with bevel gear 86. The counterclockwise rotation of input shaft 71 will cause a like rotation of bevel gear 86 that will drive bevel gear 104 at the same angular velocity in a clockwise direction as viewed from the right hand side of FIG. 4. Bearings 108 and 110 support shaft 106 that is rigidly affixed to bevel gear 104 and gear 112. Gear 112 rotates in a clockwise direction and mates with gear 114 that freely rotates counterclockwise around shaft 118 be means of bearing 116. Gear 114 is in mesh contact with gear 120 that is firmly attached to drive shaft 40 and rotates in a clockwise direction. Bearings 122 and 124 support drive shaft 40 and constrain it to rotation about its axial centerline. When two synchronous drive belts are used to move a single load, some misalignment in sprocket mounting may result. To independently adjust and synchronize each drive sprocket 38 to correctly mate with its drive belt 24, drive disks 126 are firmly affixed to opposite ends of drive shaft 40 and rotates in unison with it. Drive sprocket 38 is allowed to freely rotate around drive shaft 40 until clamp plate 128 is tightened down against drive disk 126 by screws 130.

Gear 132 is also firmly affixed to drive shaft 40 and rotates in unison with it. Gear 132 is in mesh contact with gear 134 that is allowed to freely rotate in the counterclockwise direction about shaft 136 by means of bearing 138. Gear 134 mates with reverse gear 140 that rotates freely in a clockwise direction about shaft 142 by means of bearing 144.

A mechanism that establishes the correct timing sequence when media transport carousel 14 reaches the end of its desired motion and transmission 37 reverses the rotational direction of drive sprocket 38 will now be described with reference to FIGS. 3, 4, and 6. Reverse pin 146 automatically reverses transmission 37 and is affixed to reverse pin mount 148 that is located on a shoulder relief area of gear 140. Reverse pin mount 148 can be rotated to any desired rotational position and clamped at that location by clamp plate 150 that is attached to reverse gear 140 with screws 152. Reverse pin 146 rotates about the axial centerline of reverse gear 140 and will come into contact with reverse arm pin 154 that is firmly attached to reverse arm 100.

A gearing system engages and is driven by the drive element such that the gearing system drives the reverse pin 146 to move the reverse arm 100 and clutch collar 84 to engage the second gear when the drive element is driven in the first drive element rotation direction a rotational distance.

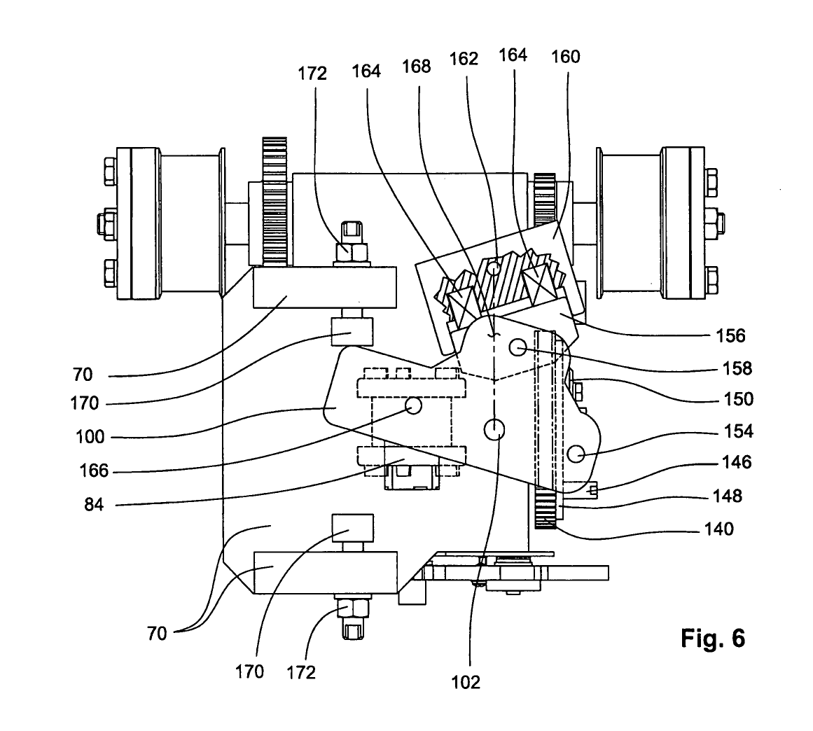

In other words, a given number of rotations of the drive element, corresponding to a given distance traveled by the magnet media carousel, will drive the reverse pin 146 to engage the reverse arm 100, thereby reversing the transmission 37. Referring to the example of FIG. 6, the reversal of transmission 37 is accomplished with the continued rotation of reverse gear 140 that causes a counterclockwise reactionary rotation of reverse arm 100 about arm pivot 102. Spring shoulder 156 is attached to reverse arm 100 by pivot pit 158 and is in sliding contact with a mating profile in spring housing 160. Spring housing 160 rotates about housing pivot 162 and holds two springs 164 in spring pockets. Springs 164 are compressed in a manner that applies a force to spring shoulder 156 that in turn moves pivot pin 158 away from housing pivot 162. The rotation of reverse arm pin 154 about arm pivot 102 also produces a like rotation of pivot pin 158 and clutch pin 166. The resulting rotation of reverse arm 100 brings clutch pin 166 into contact with the opposite side of a recessed area in clutch collar 84. At this position of reverse arm 100, the center of pivot pin 158 has rotated into a position where it intersects line 168 that bisects housing pivot 162 and arm pivot 102 thus causing spring shoulder 156 to compress springs 164 to their minimum length. Continued rotation of reverse arm 100 causes clutch pin 166 to push clutch collar 84 out of engagement with bevel gear 86. Pivot pin 158 has rotated to a position where it no longer intersects line 168 and the force from springs 164 continues the counterclockwise rotation of reverse arm 100. Clutch pin 166 continues to slide clutch collar 84 into engagement with bevel gear 88. Rotation of reverse arm 100 stops when it comes into contact with arm stop 170. Arm stop 170 can be adjusted as desired to reduce loading on thrust bearings 92 and 93 and then locked into position by lock nuts 172.

The resulting engagement of clutch collar 84 with bevel gear 88 causes a counterclockwise rotation of this gear. Bevel gear 88 produces a counterclockwise rotation of bevel gear 104 that results in a like rotation of drive sprocket 38 as viewed from the right hand side of FIG. 4 as described previously. Drive sprocket 38 interacts with belt 24 to move media transport carousel 14 in a direction that will return it to the original starting point. Rotation of drive shaft 40 causes gear 132 to produce a counterclockwise rotation of reverse gear 140 through gear 134. Reverse pin 146 also rotates counterclockwise about the rotational center of reverse gear 140. The path that reverse pin 146 traverses will bring it into contact with the reverse arm pin 154 and produce a clockwise rotation of reverse arm 100. In an identical method to that described previously, clutch pin 166 slides clutch collar 84 out of engagement with bevel gear 88 and springs 164 push clutch collar 84 into engagement with bevel gear 86. The above described process repeats until rotation on input shaft 71 stops.

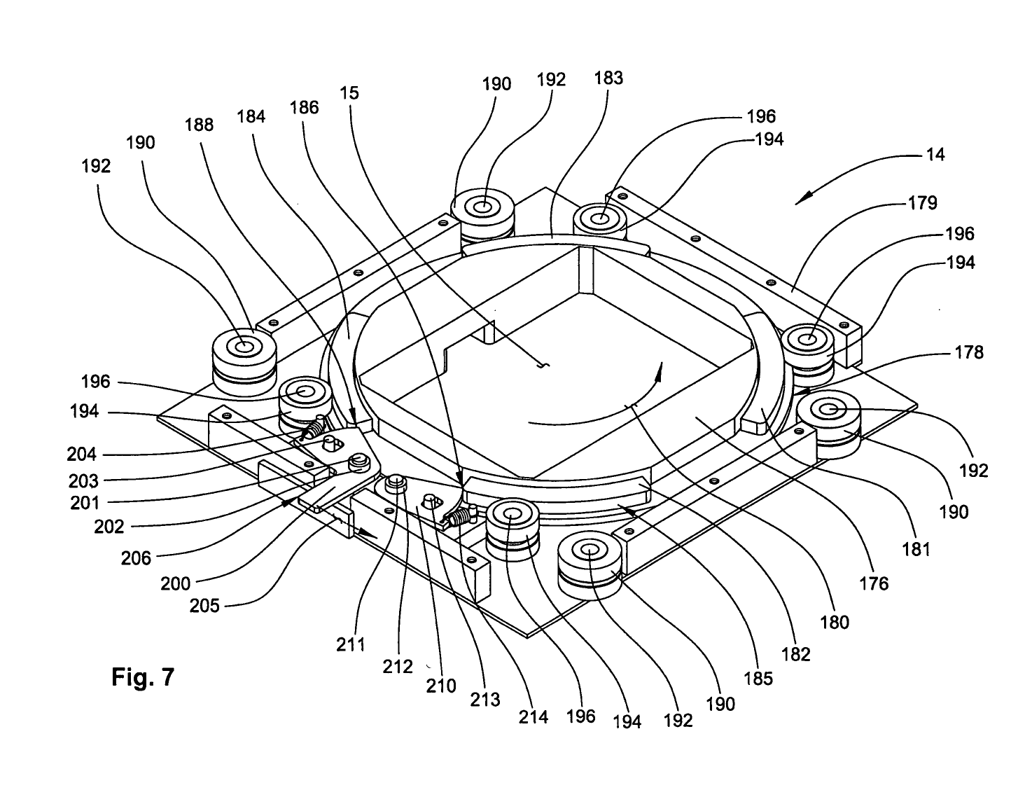

With reference to FIG. 7, a mechanism to transport the magnetic storage media through the magnetic field volume by media transport carousel 14 will be described. Rollers 190 freely rotate about axles 192 and restrict media transport carousel 14 to linear motion via groves in rollers 190 that mate with transport rails 16 and 18. A media cavity 15 engages the magnetic medium to at least partially constrain movement of the magnetic medium. The media cavity 15 is rotatable within the media transport carousel 14 and located in the center of turn table 176 that contains a turn table flange 178 around its outer periphery. Axles 196 are rigidly affixed to media transport base 179 that provides a common point of attachment for many items of media transport carousel 14. Turn table rollers 194 rotate freely about axles 196 and contain grooves that mate with turn table flange 178 to constrain turn table 176 to rotational motion about its central axis. A plurality of stops 181 through 184 are securely disposed about a periphery of the media cavity 15, each stop including a first stop side and a second stop side. Four turn table stops 181 through 184 are evenly spaced at 90 degrees with respect to each other and firmly attached to turn table flange 178. Each turntable stop 181, 182, 183, and 184 contains a turn table stop face 185. Lock arm 210 permits turn table 176 to only rotate in a counterclockwise direction as indicated by arrow 180.

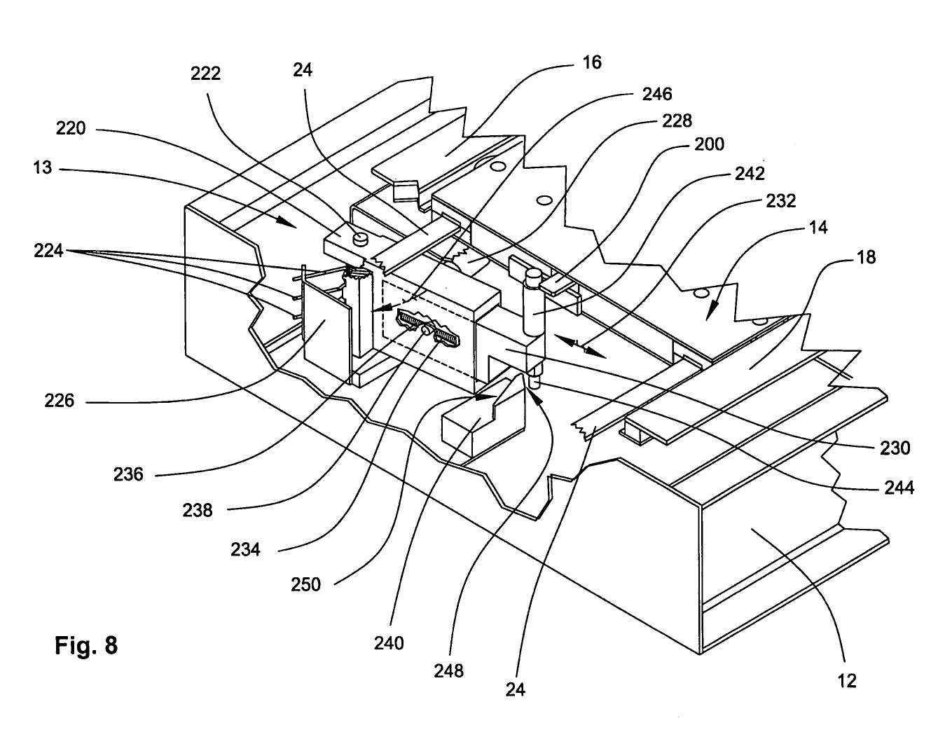

A release arm 200 is biased to engage one of the plurality of stops 181, 182, 183, or 184 at the first stop side to constrain rotation of the media cavity 15 in a first rotational direction. Release arm 200 freely rotates about shaft 201 by means of bearing 202 such that it is selectively rotatable out of engagement with one of the plurality of stops. Spring 204 is attached at one end to release arm 200 and the opposite end to transport base 179 to bias release arm 200 in a clockwise direction. The amount of engagement between release arm 200 and turn table stop 184 at engagement area 188 is determined by the location of stop pin 203. A lock release pin 242 (FIG. 8) is rotatably mounted to engage the media transport carousel 14 after the media transport carousel 14 passes a distance through the magnetic field generator 5 in the first direction. The lock release pin 242 is mounted to rotate into the release arm 200 when engaging the media transport carousel 14, thereby causing the release arm 200 to disengage one of the plurality of stops 181, 182, 183, or 184. In other words, the lock release pin 242 applies a force at location 206 to rotatably move release arm 200 in a counterclockwise manner that permits turn table 176 to be rotated in a like direction. The duration of time that the force is applied at location 206 allows turn table 176 to rotatably move through a portion of the full 90 degree motion. When the force is removed from location 206, spring 204 biases release arm 200 into contact with turn table stop face 185. After turn table 176 has rotated to a position in which contact is broken between turn table stop face 185 and release arm 200, spring 204 further biases release arm 200 clockwise until it stops against stop pin 203. The final portion of rotation of turn table 176 will bring the next successive turn table stop 183 into contact with release arm 200 at location 188.

A lock arm 210 is biased to engage one of the plurality of stops 181, 182, 183, or 184 at the second stop side to constrain rotation of the media cavity 15 in a second rotational direction. Lock arm 210 is configured to retract upon engagement with the first stop side of one of the plurality of stops 181 through 184 to allow rotation of the media cavity 15 in the first rotational direction. Lock arm 210 freely rotates about shaft 211 by means of bearing 212. Spring 214 is attached at one end to lock arm 210 and the opposite end to transport base 179 and biases lock arm 210 in a counterclockwise direction. The amount of engagement between lock arm 210 and turn table stop 182 at engagement area 186 is determined by the location of stop pin 213. As turn table 176 is rotated in a counterclockwise direction, turn table stop face 185 contacts lock arm 210 and rotates it in a clockwise manner. After turn table stop face 185 moves to a point that contact is lost with lock arm 210, spring 214 once again biases lock arm 210 back into an engaged position with the next successive turn table stop 184.

The turn table release assembly 13 will be described with reference to FIG. 8. Release housing 220 pivots freely about housing pivot 222 and is biased in a counterclockwise rotational direction by torsion springs 224. Torsion springs 224 are supported in the center by housing pivot 222 and make contact at one end with release housing 220 and the other end with spring bracket 226 which is firmly attached to frame 12. Release housing 220 is limited in the amount of counterclockwise rotation by release housing stop 228 that can be in turn adjusted to provide a means to change the timing sequence for when release arm 200 will allow the start of rotation for turn table 176.

Release housing arm 230 slides in a mating cavity of release housing 220 and in the directions of arrow 232. Return springs 234 and 236 keep return housing arm 230 in a centered position prior to and following interaction with release cam 240. Compression springs 234 and 236 are located in a long slender cavity that is machined into the side of release housing arm 230 and separated by spring separation pin 238 that is firmly attached to release housing 220. Spring 234 is compressed when release housing arm 230 moves towards housing pivot 222, and conversely spring 236 is compressed when release housing arm 230 moves away from housing pivot 222. Lock release pin 242 and cam pin 244 are rigidly affixed to release housing arm 230. The path of motion for media transport carousel 14 intersects with the location of lock release pin 242 and imparts a rotational motion of release housing 220 in the direction of arrow 246. As release housing 220 rotates in a clockwise direction, cam pin 244 comes into contact with release cam 240 and follows the prescribed cam release profile 248. Cam release profile 248 causes release housing arm 230 and lock release pin 242 to move in a direction that will impart motion of release arm 200. Conversely when motion of media transport carousel 14 is reversed at the end of its travel, release housing 220 rotates in a counterclockwise manner and cam pin 244 contacts release cam 240 on the cam reset profile 250 side.

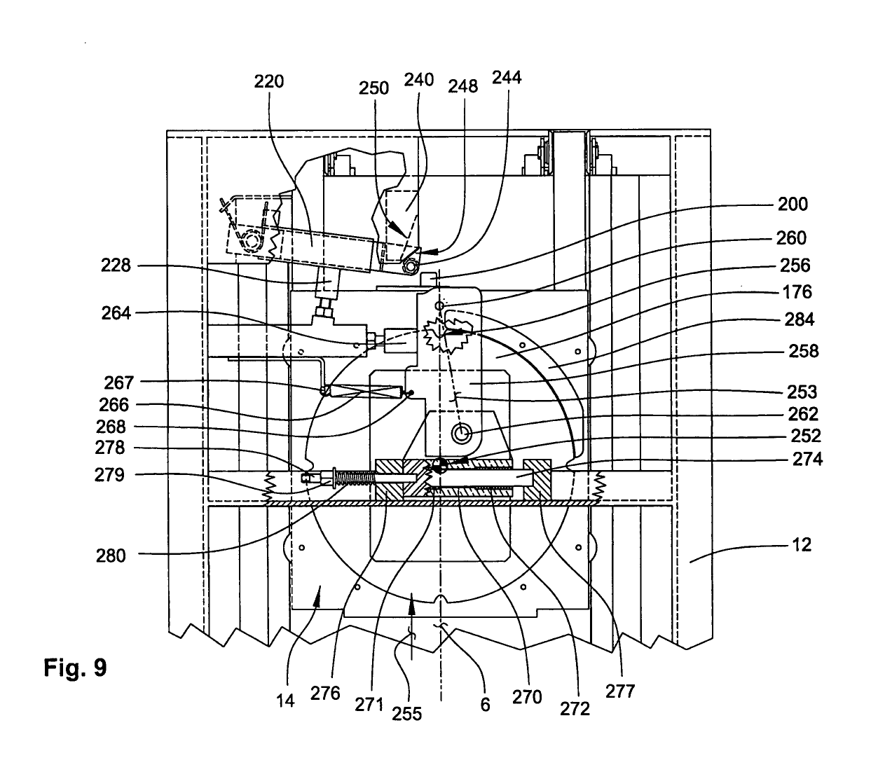

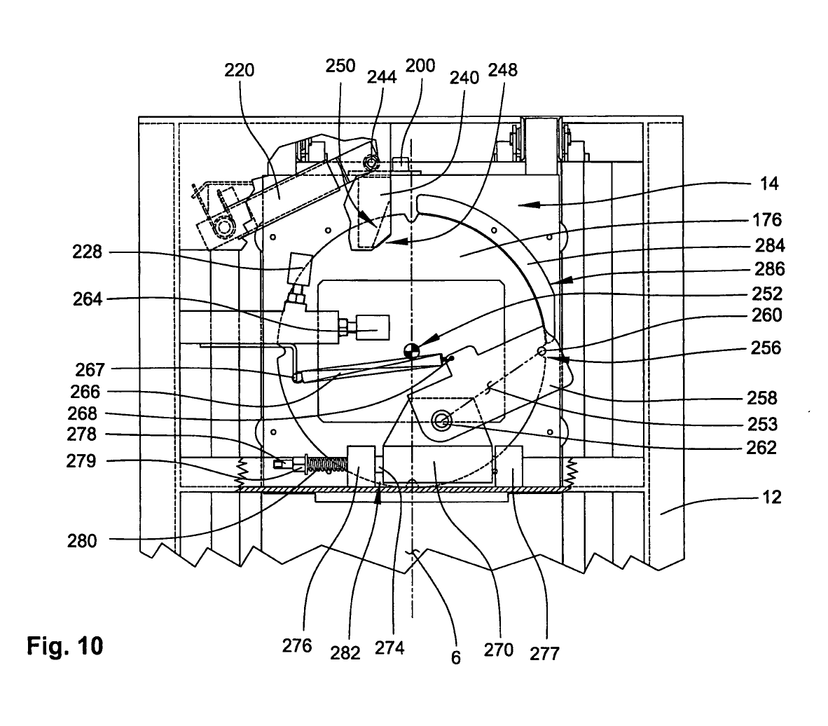

FIGS. 9 and 10 illustrate an example mechanism used to rotate turn table 176 at the conclusion of release arm 200 rotating to an unlock condition. A rotation arm 258 is attached to rotation pin 260, and rotation arm 258 is rotatably mounted in the system such that rotation pin 260 engages a notch 256 in the media transport carousel 14 when the media transport carousel 14 passes a distance through the magnetic field generator 5. Rotation arm 258 is configured to rotate as the notch 256 applies a force to the rotation pin 260 during movement of the media transport carousel 14 in the first direction such that the rotation pin 260 rotates the media transport carousel 14 in a first rotational direction during movement of the media transport carousel 14 in the first direction. In this illustrated example, turn table 176 rotates 90 degrees about turn table center 252 as the turn table center 252 traverses along media conveyance path 6. Four rotation pin notches 256 are equally spaced at 90 degrees to each other around the outer periphery of turn table 176. Rotation arm 258 is located above turn table 176 and pivots freely on arm pivot 262 that is rigidly affixed to arm pivot base 270.

Allowing arm pivot 262 to move in a controlled manner prevents a locked condition of the mechanism. Arm pivot base 270 is allowed to freely slide along guide 274 by means of sleeve bearings 271 and 272. Guide 274 is soundly affixed to guide bases 276 and 277 that are in turn both affixed to frame 12. Spring guide 278 is attached to arm pivot base 270 and extends through a clearance hole in guide base 276. Spring 280 fits over spring guide 278 and is captivated between guide base 276 and spring retainer 279 to bias arm pivot base 270 toward guide base 276.

Many different operating conditions can be achieved to meet a specific design requirement by simply changing the location of rotation arm pivot 262 or rotation pin 260. For example, if one desired to increase the amount of rotational force produced and travel length of media transport carousel 14 to accomplish the 90 degree rotation of turn table 176, one would move rotation arm pivot 262 away from line 6. If one desired to shorten the travel distance of media transport carousel 14 to achieve 90 degrees of turn table 176 rotation and produce more rotational force on it, rotation arm pivot 262 would be moved further away from line 6 and the distance from rotation pin 260 to rotation arm pivot 262 would be shortened.

Rotation pin 260 is firmly attached to rotation arm 258 and extends from it in the direction of turn table 176. Spring 266 is attached at one end to frame 12 at location 267 and the other end to the rotation arm 258 at location 268. Spring 266 returns rotation arm 258 to arm stop 264 at the conclusion of an indexing of turn table 176 and ensures proper engagement alignment of rotation pin 260 to one of the rotation pin notches 256. The springs can be changed to one of many different spring forms by simply changing the mounting configuration while still keeping the same mechanical intent.

Motion of turn table center 252 along media conveyance path 6 in the direction of arrow 255 brings rotation pin notch 256 into contact with rotation pin 260. The continued motion of media transport carousel 14 causes rotation pin 260 to apply a force on rotation pin notch 256 along line 253 and thus produces a rotational moment on turn table 176 about turn table center 252. As rotation arm 258 and turn table 176 continue in their clockwise motion, rotation pin 260 becomes captured inside of rotation pin notch 256 by return pin guide 284. It is possible that the direction of motion for media transport carousel 14 can be reversed when the turn table 176 has been rotated through only a portion of its complete displacement. Return pin guide 284 prevents rotation pin 260 from disengaging from rotation pin notch 256 prematurely and leaving turn table 176 in an indeterminate rotated condition. For example, if one were to reverse motion of media transport carousel 14 while rotation pin 260 is captured in rotation pin notch 256, rotation arm 258 will cause rotation pin 260 to push turn table 176 in a counterclockwise direction with rotation arm 258 following along. As turn table 176 rotates to its original starting position, it will become relocked into position.

As media transport carousel 14 continues its motion in the direction of arrow 255, rotation arm 258 rotates in a clockwise direction until the complete 90 degree indexed rotation of turn table 176 is complete as shown in FIG. 10. Rotation arm 258 will pull arm pivot base 270 in the direction of guide base 277 to open up gap 282 and result in additional compression of spring 280. Completion of the rotation portion of the degaussing process is finished upon the media turn table 176 becoming locked into its new indexed position.

Upon reversal of transmission assembly 37 and the direction of motion for media transport carousel 14 being opposite that of arrow 255, spring 280 will pull arm pivot base 270 back in the direction of guide base 276. Continued motion of media transport carousel 14 causes rotation arm 258 to rotate in a clockwise direction until rotation pin 260 disengages from rotation pin notch 256. Spring 266 biases rotation arm 258 in a counterclockwise direction and causes rotation pin 260 to slide along the outside surface 286 of return pin guide 284. As media transport carousel 14 moves away from rotation pin 260, spring 266 returns rotation arm 258 to its centered position at arm stop 264.

A system built according the teachings of this disclosure may then operate in accordance with the following method to degauss magnetic media. First, the system moves a magnetic storage medium through a magnetic field in a first direction in response to an application of a rotational force in a first rotational direction to a portion of the system. The system then automatically rotates the magnetic storage medium in response to continued application of the rotational force in the first rotational direction after moving the magnetic storage medium through the magnetic field. The system moves the magnetic storage medium through the magnetic field in a second direction in response to continued application of the rotational force in the first rotational direction.

So configured, continuous application of a rotational force will expose a magnetic medium to a magnetic field, rotate the medium, and expose the rotated magnetic medium to the magnetic field to improve exposure of the medium to various directions of magnetic fields. The apparatus allows one to degauss a medium without electric power and reduces user error by not requiring the user to manually remove and rotate the medium or to change direction of rotational force input driving the medium.

Those skilled in the art will recognize that a wide variety of modifications, alterations, and combinations can be made with respect to the above described example without departing from the spirit and scope of the invention. Indeed much of the described mechanisms may be modified to achieve the same results, and such modifications, alterations, and combinations are to be viewed as being within the ambit of the inventive concept. Also, every element described above in connection with the illustrated example is not necessary for the embodiments described in the following claims.

1. A system for degaussing magnetic media comprising:
a media transport carousel mounted within the system to move in a first direction into the system and through a magnetic field generator and to move in a second direction through the magnetic field generator and out of the system;
a flexible drive member in driving communication with the magnetic media carousel and a drive element;
an input shaft;
an automatically reversible transmission in communication with the input shaft to transmit via a plurality of gears rotational force from the input shaft in a first rotational direction to drive the drive element in a first drive element rotation direction to move the media transport carousel in the first direction, the automatically reversible transmission configured to transmit via a second plurality of gears the rotational force from the input shaft in the first direction to drive the drive element in a second drive element rotation direction to move the media transport carousel in the second direction;
a media rotation assembly selectively engaging the media transport carousel to automatically rotate the media transport carousel after the media transport carousel passes a distance through the magnetic field generator in the first direction.

2. The system of claim 1 wherein the media transport carousel further comprises:
a media cavity that engages the magnetic medium to at least partially constrain movement of the magnetic medium, the media cavity rotatable within the media transport carousel;
a plurality of stops securely disposed about a periphery of the media cavity, each stop including a first stop side and a second stop side;
a release arm biased to engage one of the plurality of stops at the first stop side to constrain rotation of the media cavity in a first rotational direction and selectively rotatable out of engagement with one of the plurality of stops;
a lock arm biased to engage one of the plurality of stops at the second stop side to constrain rotation of the media cavity in a second rotational direction, the lock arm configured to retract upon engagement with the first stop side of one of the plurality of stops to allow rotation of the media cavity in the first rotational direction.

3. The system of claim 2 wherein the media rotation assembly further comprises a lock release pin rotatably mounted to engage the media transport carousel after the media transport carousel passes a distance through the magnetic field generator in the first direction, the lock release pin mounted to rotate into the release arm when engaging the media transport carousel causing the release arm to disengage one of the plurality of stops.

4. The system of claim 1 further comprising:
a rotation pin;
a rotation arm attached to the rotation pin, the rotation arm rotatably mounted in the system such that the rotation pin engages a notch in the media transport carousel when the media transport carousel passes a distance through the magnetic field generator;
the rotation arm configured to rotate as the notch applies a force to the rotation pin during movement of the media transport carousel in the first direction such that the rotation pin rotates the media transport carousel in a first rotational direction during movement of the media transport carousel in the first direction.

5. The system of claim 1 wherein the automatically reversible transmission further comprises:
a clutch collar driven by the input shaft, the clutch collar selectively engaging one of a first gear in driving communication with the drive element and a second gear in driving communication with the drive element such that when the clutch collar engages and drives the first gear the magnetic media carousel is driven in the first direction and when the clutch collar engages and drives the second gear the magnetic media carousel is driven in the second direction;
a reverse arm in communication with the clutch collar to automatically bias the clutch collar to engage the second gear after the media transport carousel passes a distance through the magnetic field generator in the first direction.

6. The system of claim 1 further comprising a clutch in communication with the input shaft to limit input torque applied to the input shaft.

7. The system of claim 1 further comprising a rotation limiting device engaging at least a portion of the system to substantially limit rotation of the input shaft to rotation in one direction.

8. An apparatus for transmission of rotation in a single rotational direction into reciprocating linear motion through a magnetic field comprising:
an input shaft;
a clutch collar driven by the input shaft that selectively engages one of a first gear in driving communication with a drive element and a second gear in driving communication with the drive element such that when the clutch collar engages and drives the first gear, the drive element is driven in a first drive element rotation direction, and when the clutch collar engages and drives the second gear, the drive element is driven in a second drive element rotation direction;
a reverse arm controlling the clutch collar by automatically biasing the clutch collar to engage the second gear after the drive element rotates a rotational distance in the first drive element rotation direction.

9. The apparatus of claim 8 further comprising:
a reverse pin;
a gearing system engaging and driven by the drive element such that the gearing system drives the reverse pin to move the reverse arm and clutch collar to engage the second gear when the drive element is driven in the first drive element rotation direction a rotational distance.

10. An apparatus for automatic rotation of a magnetic medium after passage through a magnetic field generator comprising:
a lock release pin rotatably mounted to engage a media transport carousel after the media transport carousel passes a distance through the magnetic field generator, the lock release pin mounted to rotate into a release arm disposed on the media transport carousel when engaging the media transport carousel causing the release arm to disengage one of a plurality of stops disposed on the media transport carousel;
a rotation pin;
a rotation arm attached to the rotation pin, the rotation arm rotatably mounted in the magnetic degaussing system such that the rotation pin engages a notch in the media transport carousel when the media transport carousel passes the distance through the magnetic field generator;
the rotation arm configured to rotate as the notch applies a force to the rotation pin during movement of the media transport carousel in the first direction such that the rotation pin rotates the media transport carousel in a first rotational direction during movement of the media transport carousel in the first direction.

11. A method for degaussing magnetic media using a system for degaussing magnetic media comprising:
moving a magnetic storage medium through a magnetic field in a first direction in response to an application of a rotational force in a first rotational direction to a portion of the system;
automatically rotating the magnetic storage medium in response to continued application of the rotational force in the first rotational direction after moving the magnetic storage medium through the magnetic field;
moving the magnetic storage medium through the magnetic field in a second direction in response to continued application of the rotational force in the first rotational direction.

12. An apparatus for degaussing magnetic media comprising:
a means for moving a magnetic storage medium through a magnetic field in a first direction in response to an application of a rotational force in a first rotational direction;
a means for automatically rotating the magnetic storage medium after moving the magnetic storage medium through the magnetic field in response to continued application of the rotational force in the first rotational direction;
a means for moving the magnetic storage medium through the magnetic field in a second direction in response to continued application of the rotational force in the first rotational direction.
